(19) United States
(12) Patent Application Publication
(10) Pub. No.: US 2011/0091225 A1
(43) Pub. Date: Apr. 21, 2011

(54) IMAGE HEATING APPARATUS

(75) Inventor: Naoyuki Yamamoto, Kashiwa-shi (JP)

(73) Assignee: CANON KABUSHIKI KAISHA, Tokyo (JP)

(21) Appl. No.: 12/908,509

(22) Filed: Oct. 20, 2010

(30) Foreign Application Priority Data
Oct. 21, 2009 (JP) 2009-242252(PAT.)

(51) Int. Cl. G03G 15/20

(52) U.S. Cl. 399/33

(57) ABSTRACT

An image heating apparatus includes a coil; a rotatable image heating member for generating heat by a magnetic flux generated by the coil to heat an image on a recording material; a voltage source for applying a high frequency current to the coil; a temperature detecting member for detecting a temperature of the image heating member; control device for controlling electric power supply to the coil from the voltage source on the basis of an output of the temperature detecting member such that the temperature of the image heating member is maintained at a set temperature T; and protecting device for stopping the electric power supply to the coil when the output of the temperature detecting member indicates a predetermined abnormal temperature Te, wherein at least a part of the image heating member is made of a magnetism-adjusted alloy having a predetermined magnetic permeability decrease start temperature Tc′ and a predetermined Curie temperature, and wherein T≦Tc′<Te<Tc.

### FIELD OF THE INVENTION AND RELATED ART

The present invention relates to an image heating apparatus of the magnetic induction type, which is employed by an electrophotographic (electrostatic) image forming apparatus, such as a copying machine, printer, a facsimileing machine, and a multi-functional image forming apparatus capable of performing two or more functions of the preceding examples of image forming apparatus, to heat an image on a sheet of recording medium.

One of the fixing apparatuses which effectively prevents its image heating member from unwantedly increasing in temperature across its out-of-sheet-path-portions is a fixing apparatus of the induction heating type, the image heating member of which is made of a magnetic metallic alloy, which has been adjusted in curie temperature to a preset level (Japanese-Laid-open Patent Application 2005-208623). A fixing apparatus of this type is provided with a temperature detecting means which is for detecting the temperature of the image heating member. More specifically, the temperature detecting means is positioned so that it can detect the temperature of the portion of the image heating member, which falls within the recording medium path regardless of recording medium size. In operation, the electric current to be supplied to the exciter coil of the fixing apparatus is controlled in amperage and/or frequency in response to the temperature of the image heating member detected by the temperature detecting means so that the detected temperature of the image heating member converges to the preset temperature level (target temperature). Further, as the temperature of the image heating member detected by the temperature detecting means reaches a preset anomaly detection temperature, it is determined that the image heating apparatus is abnormal in terms of temperature, and the operation is interrupted; heating of the heating member is interrupted.

If the image heating temperature of an image heating apparatus, such as the above described one, is set to be higher than a temperature level Tc′, at which the component of the image heating member, in which heat is generated by magnetic induction, suddenly begins to reduce in relative magnetic permeability, the image heating member substantially fluctuates in the amount by which heat is generated therein, making it difficult to precisely control the image heating member in temperature. On the other hand, if the image heating temperature is set to a level higher than the Curie temperature Tc of the heat generating component of the image heating member, the coil begins to suddenly reduce in load resistance as soon as the temperature of the image heating member exceeds the Curie temperature Tc. With the reduction of the load resistance of the coil, the amount by which electric current is allowed to flow through the coil increases, increasing thereby the amount by which eddy current is induced in the heat generating component of the image heating member. Consequently, the image heating member is heated by thee larger amount of electric power than the amount preset for temperature control. If the eddy current is continuously induced by an excessive amount, the increase in the temperature of the image heating member is accelerated, which in turn further increasing the amount by which the eddy current is induced, overloading thereby the high frequency electric power source from which high frequency electric current is supplied to the coil. Thus, it is desired that the target temperature for image heating is set to a level which is lower than the temperature Tc′ at which the heat generating component of the image heating member begins to suddenly reduce in relative magnetic permeability, so that the image heating member remains more stable in temperature. Further, for the purpose of preventing the out-of-sheet-path-portions of the image heating member from excessively increasing in temperature while a substantial number of small sheets of recording medium are continuously conveyed through the image heating apparatus, it is desired that the target temperature for image heating is set to be as close as possible to the temperature Tc′. Even if the image heating apparatus is structured as described above, the temperature of the image heating member sometimes reaches the Curie temperature Tc, overloading the electric power source, because of the setting of the anomaly detection temperature.

### SUMMARY OF THE INVENTION

Thus, the primary object of the present invention is to provide an image heating apparatus, the temperature of the heat generating component of the heat generating member of which does not reach the curie temperature of the heat generating component of the image heating member, even if the target temperature for image heating is set to a value within a temperature range which is close to the curie temperature, and in which the heat generating component is stable in the amount by which heat is generated therein.

According to an aspect of the present invention, there is provided an image heating apparatus comprising a coil; a rotatable image heating member for generating heat by a magnetic flux generated by said coil to heat an image on a recording material; a voltage source for applying a high frequency current to said coil; a temperature detecting member for detecting a temperature of said image heating member; control means for controlling electric power supply to said coil from said voltage source on the basis of an output of said temperature detecting member such that the temperature of said image heating member is maintained at a set temperature T; and protecting means for stopping the electric power supply to said coil when the output of said temperature detecting member indicates a predetermined abnormal temperature Te, wherein at least a part of said image heating member is made of a magnetism-adjusted alloy having a predetermined magnetic permeability decrease start temperature Tc′ and a predetermined Curie temperature, and wherein T≦Tc′<Te<Tc.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1(a) is a schematic sectional view of the image forming apparatus in the first preferred embodiment of the present invention, and FIG. 1(b) is an enlarged cross-sectional view of the essential portions of the fixing apparatus (image heating apparatus of electromagnetic induction type) in the first embodiment.

FIG. 2(a) is a schematic front view of the essential portions of the fixing apparatus in the first embodiment, and FIG. 2(b) is a vertical sectional view of the essential portions of the fixing apparatus in the first embodiment, at a vertical plane which coincides with the axial line of the image heating member of the apparatus.

FIG. 3(a) is a schematic drawing for describing the heat generation principle of the fixation roller in the first embodiment, and FIG. 3(b) is a graph which shows the dependency of the magnetic permeability of the heat generating component of the image heating member upon the temperature of the heat generating component.

FIG. 4(a) is a schematic drawing for describing the overall amount of load resistance of the coil when the out-of-sheet-path-portions of the image heating member are significantly higher in temperature than the sheet-path-portion of the image heating member. FIG. 4(b) is a graph which shows the dependency of the magnetic permeability of the heat generating component of the image heating member upon the temperature of the heat generating component, in the second preferred embodiment of the present invention.

### DETAILED DESCRIPTION OF THE PREFERRED EMBODIMENTS

### Embodiment 1

### (1) Example of Image Forming Apparatus:

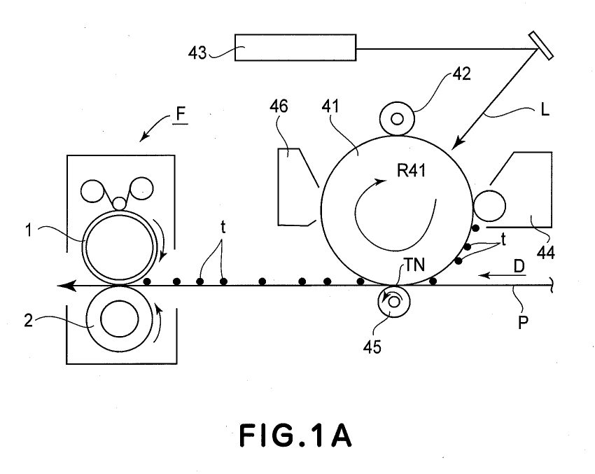

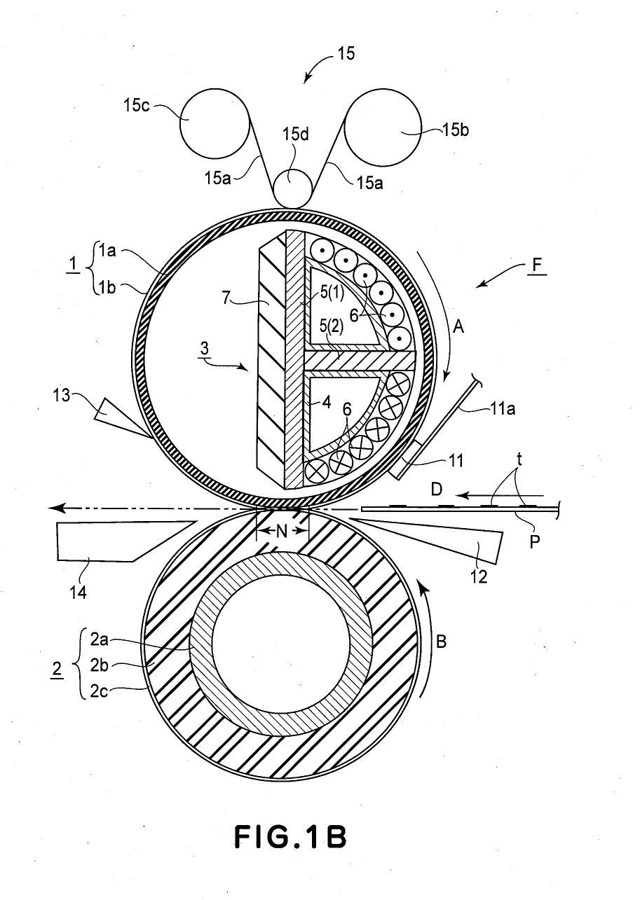

FIG. 1(a) is a schematic sectional view of an example of an image forming apparatus whose fixing apparatus F is an image forming apparatus of the magnetic induction type, which is in accordance with the present invention. This image forming apparatus is a digital image forming apparatus (copying machine, printer, facsimile, multifunction apparatus capable of performing two or more functions of preceding apparatuses, etc.), which uses an electrophotographic processes, and a laser-based scanning (exposing) method. Designated by a referential code 41 is an electrophotographic photosensitive member as an image bearing member. The photosensitive member 41 is in the form of a rotatable drum (which hereafter will be referred to as drum 41). It is rotated in the clockwise direction indicated by an arrow mark R41 at a preset peripheral velocity. Designated by a referential code 42 is a first charging device (charge roller of contact type). As the photosensitive drum 41 rotates, the charge roller 42 uniformly charges the peripheral surface of the drum 41 to a preset level Vd (dark potential level, which in this embodiment is negative). Designated by a referential code 43 is a laser beam scanner as a drum exposing means, which scans (exposes) the uniformly charged portion of the peripheral surface of the drum 41, with a beam L of laser light which it outputs while modulating the beam L in response to the digital image formation signals inputted into the laser beam scanner 43 from a host apparatus (unshown), such as an image reading apparatus, a computer, a facsimile (in receiving mode), and the like. As the uniformly charged portion of the peripheral surface of the drum 41 is exposed, the exposed points of the uniformly charged portion of the peripheral surface of the drum 41 reduce in the absolute value of their potential level to light potential level V1. Thus, an electrostatic latent image, which reflects the image formation signals, is formed on the peripheral surface of the drum 41. The electrostatic latent image is developed by a developing device 44. More specifically, negatively charged toner adheres to the points of the charged portion of the peripheral surface of the drum 41, which have reduced in potential to V1 (light potential level), developing thereby (in reverse) the electrostatic latent image into a visible image t (image made of toner, which hereafter may be referred to simply as toner image t). Meanwhile, a sheet P of recording medium (which is object to be heated, and will be referred to as recording sheet P hereafter) is fed into the main assembly of the image forming apparatus from the sheet feeding portion (unshown) of the apparatus, and is delivered, with a proper timing, to the transfer nip TN, which is the area of contact between the transfer roller 45 (toner image transferring member), to which transfer bias is being applied, and the drum 41, and is conveyed through the nip TN. As the recording sheet P is conveyed through the nip TN, the toner image t on the peripheral surface of the drum 41 is transferred onto the recording sheet P as if it is peeled away from the drum 41, starting at the leading edge of the toner image t in terms of the recording sheet conveyance direction. As the recording sheet P is conveyed out of the nip TN, it is introduced into the fixing apparatus F, through which it is conveyed. As it is conveyed through the fixing apparatus F, it and the unfixed toner image t thereon are subjected to heat and pressure, whereby the unfixed toner image t becomes fixed to the recording sheet P. Thereafter, the recording sheet P is discharged as a finished print (copy) from the image forming apparatus. After the separation of the recording sheet P from the peripheral surface of the drum 41, the peripheral surface of the drum 41 is cleaned by the cleaning apparatus 46; substances such as toner particles remaining on the peripheral surface of the drum 41 are removed by the cleaning apparatus 46 so that the drum 41 can be repeatedly used for image formation.

### (2) Fixing Apparatus F

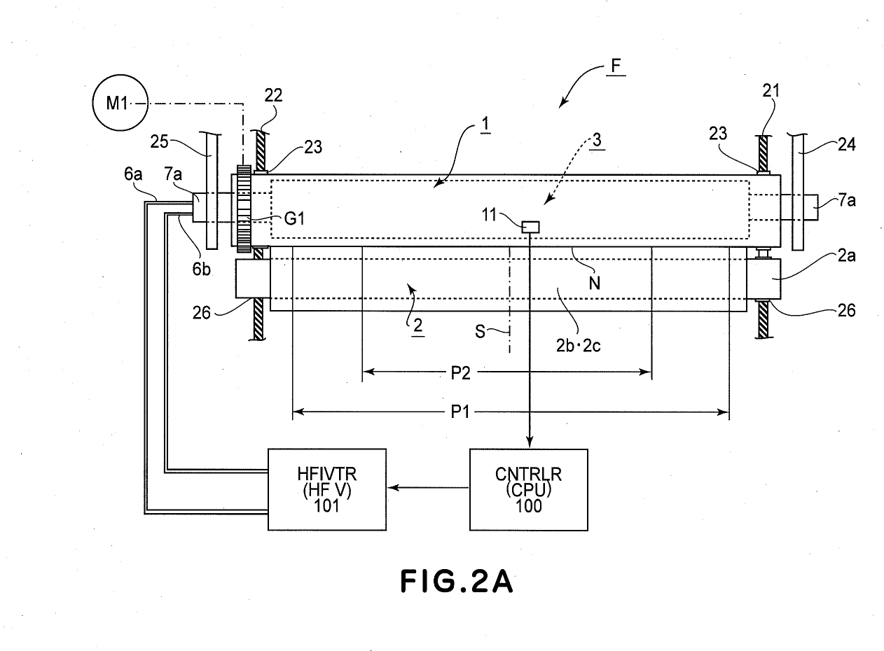

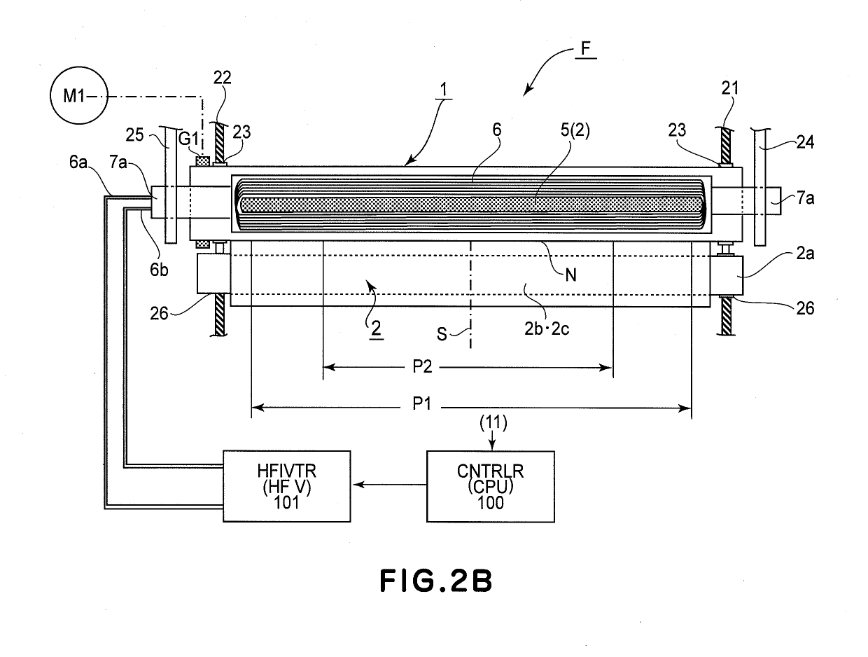

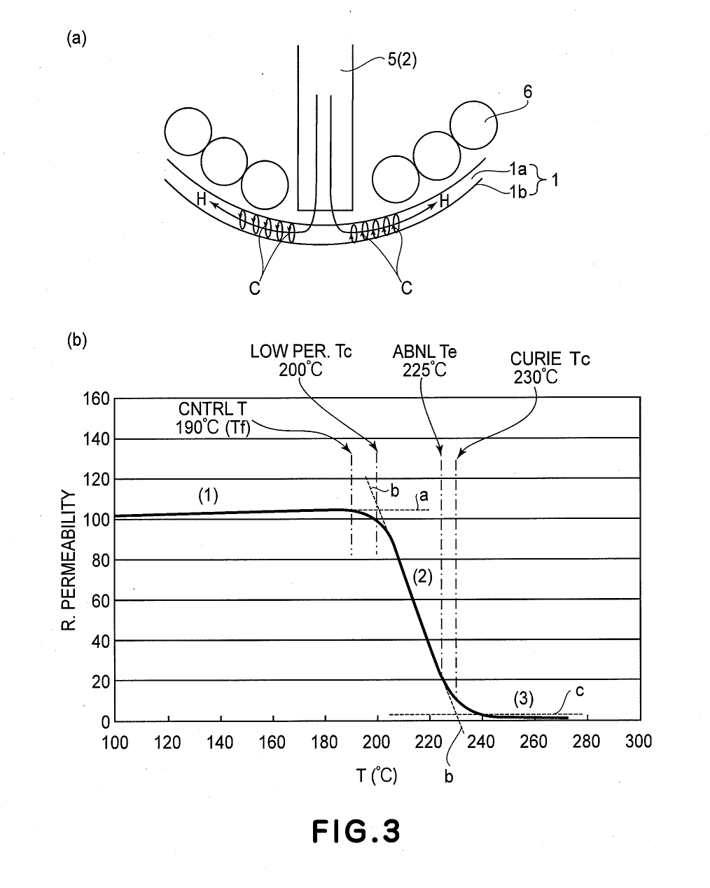

FIG. 1(b) is an enlarged schematic cross-sectional view of the essential portions of the fixing apparatus F. FIG. 2(a) is a front view of the essential portions of the fixing apparatus F, and FIG. 2(b) is a schematic vertical sectional view of the essential portions of the fixing apparatus F, at the vertical plane which coincides with the axial line of the heating member (heat roller) of the apparatus F. The “front surface” of the fixing apparatus F means the surface of the fixing apparatus F, which faces the direction from which the recording sheet P is introduced into the apparatus F. This fixing apparatus is a heating apparatus of the induction heat generation type, and employs a heat roller in which heat is generated by magnetic induction. It has also a coil 6 (exciter coil) and a high frequency invertor 101 (high frequency electric power source), which is an electric power source for flowing high frequency electric current through the coil 6. It has also a heat roller 1 (rotational heating member which has electrically conductive layer and generates heat as it is subjected to magnetic flux) as an image heating member. It generates heat therein as it is exposed to the magnetic flux H (FIG. 3(a)) generated by the coil 6. At least a part of the heat roller is formed of a magnetic alloy, the Curie temperature and magnetic permeability loss start temperature Tc of which has been adjusted to a preset temperature level.

The fixing apparatus F has also an elastic pressure roller 2 as a pressure applying member which is for forming a nip N (fixation nip) between itself and the roller 1 (pressure applying means which holds the recording sheet P by being pressed against the roller 1). Further, the fixing apparatus F has a thermistor 11 as a temperature detecting means for detecting the temperature of the roller 1, and a control circuit 100 (CPU) as a controlling means which controls the electric power supply from the inverter 101 to the coil 6, so that the temperature of the roller 1 converges to a preset level T. In essence, the fixing apparatus F is an apparatus which heats a sheet P of recording medium, on which an unfixed toner image t is present, while conveying the recording sheet P through its nip N.

The roller 1 is cylindrical, and is 40 mm in external diameter, 1.0 mm in wall thickness, and 340 mm in length. It has a cylindrical metallic core 1a made of an electrically conductive substance, more specifically, a metallic alloy formed of a combination of iron, nickel, chrome, etc., and adjusted in magnetism (adjusted in curie temperature to a preset level). The metallic core 1a is covered with a surface layer 1b for improving the roller 1 in parting performance (toner releasing performance). The surface layer 1b is formed of a fluorinated resin such as PFA or PTFE, and is 30 μm in thickness. Incidentally, a heat resistant elastic layer formed of silicone rubber or the like may be placed between the metallic core 1a and surface layer 1b in order to improve the apparatus F in the fixation of high quality images such as multicolor images. In this embodiment, the metallic core 1a is formed of magnetic metallic alloy created by combining iron, nickel, chrome, etc., in such a ratio that its magnetic permeability loss start temperature level Tc′ becomes 200° C., and also, the curie temperature Tc, above which the roller 1 (metallic core 1a) is stable in magnetic permeability at a lower value, becomes 230° C. The magnetic permeability loss start temperature Tc′ was set to a level which is higher than a preset image heating level Tf (which hereafter may be referred to as fixation temperature, which is 190° C. in this embodiment), that is, the level at which the image on the recording sheet P is heated during an image forming operation. Further, the Curie temperature Tc was set to a level higher than an anomaly detection temperature Te (which was 225° C. in this embodiment).

The roller 2 is an elastic roller, and is 38 mm in external diameter and 330 mm in length. It comprises: a metallic core 2a; a heat resistant elastic layer 2b which is coaxial and was integrally formed with the metallic core 2a in a manner to completely cover the peripheral surface of the metallic core 2a; and a surface layer 2c which covers the entirety of the outward surface of the elastic layer 2b. The metallic core 2a is a piece of metallic pipe, which is 28 mm in external diameter and 330 mm in length. The elastic layer 2b is formed of a heat resistant elastic substance, and is 5 mm in thickness. The surface layer 2c is a thin layer formed of a fluorinated resin such as PFA and PTFE, and is 30 μm in thickness. The roller 2 is under the roller 1, and is parallel to the roller 1. It is rotatably held by the aforementioned front and rear plates 21 and 22, between the two plates 21 and 22, at its front and rear end portions, with the presence of a pair of bearings 26 between the front and rear end portions and the front and rear plates 21 and 22, respectively. The rollers 1 and 2 are kept pressed against each other by a preset amount of pressure applied by an unshown pressure applying mechanism so that the elastic layer 2b remains compressed by the preset amount of pressure, creating a fixation nip N (heating-and-pressuring nip) between the two rollers 1 and 2. The nip N is roughly 5 mm in dimension in terms of the recording sheet conveyance direction D. It is where the recording sheet P, on which an unfixed toner image t is present, is conveyed, while remaining pinched by the two rollers 1 and 2, so that the unfixed toner image t is thermally fixed to the recording sheet P. Incidentally, the “lengthwise direction” of the structural components of the image heating apparatus in accordance with the present invention means the direction perpendicular to the lengthwise edges of the nip N, that is, the direction perpendicular to the recording sheet conveyance direction D. Further, “their center and end portions” means their center and end portions in terms of their “lengthwise direction”.

The coil assembly 3 has a bobbin 4, a magnetic core 5 (combination of portions 1 and 2 made of magnetic substance) (cores made of magnetic substance), a coil 6, an electrically insulative stay 7, etc. The core 5 is held by the bobbin 4. The coil 6 was formed by winding a piece of electric wire (Litz wire) around the bobbin 4. The bobbin 4, core 5, and coil 6 are integrated as a unit which is immovably supported by the stay 7. The coil assembly 3 is in the cylindrical hollow of the roller 1. The assembly 3 is immovably attached to the front and rear assembly supporting members 24 and 25, by the lengthwise ends 7a and 7b of the stay 7, respectively, with the provision of a preset amount of gap between the inward surface of the roller 1 and the coil 6. The coil assembly 3 (integrated combination of bobbin 4, core 5, and coil 6) is within the roller 1, being positioned so that each of its lengthwise ends is on the inward side of the corresponding end opening of the roller 1. The core 5 is made of a substance such as ferrite and Permalloy, which is high in magnetic permeability and low in residual magnetic flux density. The core 5 is for guiding the magnetic flux generated by the coil 6, to the metallic core 1a. The core 5 in this embodiment is in the form of a letter T in cross-section. It is an integral combination of a side portion 1 of the core 5, which corresponds to the horizontal portion of a letter T, and a center portion 2 of the core 5, which corresponds to the vertical portion of a letter T. The coil 6 was made by winding multiple times a piece of Litz wire around the combination of the bobbin 4 and the center portion 1 of the core 5 so that the coil 6 would be formed in the pattern of a long and narrow boat which perfectly fits around the bobbin 4, and the lengthwise direction of which is parallel to the lengthwise direction of the combination of the bobbin 4 and core 5. Thus, the lengthwise direction of the core 6 is parallel to the lengthwise direction of the roller 1, that is, the direction parallel to the direction of the rotational axis of the roller 1. Further, the coil 6 was formed so that its external contour matches the internal contour of the roller 1. Designated by referential codes 6a and 6b are two lead wires (electric power supply lines) of the coil 6, and are extended outward of the assembly 3 from the rearward end of the stay 7, being in connection with the invertor 101.

The invertor 101 has a switching element, which can be turned on and off with a preset frequency to flow electric current through the coil 6 with the preset frequency. The invertor 101 in this embodiment outputs a preset amount of voltage (100 V). The amount by which electric power is supplied to the coil 6 from the invertor 101 is set by controlling the invertor 101 in amperage, and the length of time the switching element is kept turned on. The thermistor 11 is outside the roller 1, and is held by the apparatus main assembly, with the placement of a supporting member 11a between the thermistor 11 and the main frame. It detects the surface temperature of the roller 1. It may be of the contact type or non-contact type. The thermistor in this embodiment opposes the coil 6, with the presence of the wall of the roller 1 between the thermistor 11 and the coil 6, and is kept elastically pressed upon the peripheral surface of the roller 1 by the supporting member 11a, which is elastic. The roller temperature signal outputted by the thermistor 11 is inputted into the control circuit 100. Designated by a referential code 12 is a recording sheet guiding front plate. As the recording sheet P is conveyed from the image forming mechanism to the apparatus F, the recording sheet guiding front plate 12 guides the recording sheet P to the entrance of the nip N. Designated by a referential code 13 is a recording sheet parting claw, which helps the recording sheet P separate from the roller 1 by preventing the recording sheet P from wrapping around the roller 1 as the recording sheet P comes out of the nip N. Designated by a referential code 14 is a recording sheet guiding rear plate, which guides the recording sheet P as the recording sheet P comes out of the apparatus F after the fixation. The recording sheet guiding rear plate 14 guides the recording sheet P toward the recording sheet outlet of the image forming apparatus as the recording sheet P comes out of the nip N. The material for the bobbin 4, stay 7, and parting claw 13 is a heat resistance and electrically insulative engineered plastic. The anomaly detection temperature Te (which is 225° C. in this embodiment) is set based on the highest temperature level which the abovementioned engineered plastic can withstand. Designated by a referential code G1 is a drive gear which is immovably fitted around the rear end portion of the roller 1. As driving force is transmitted to the gear G1 from a roller driving power source M1 through a mechanical power transmission system (unshown), the roller 1 rotates in the clockwise direction, which is indicated by an arrow mark A1, at a preset peripheral velocity, which in this embodiment is 300 mm/sec. The roller 2 is rotated in the counterclockwise direction indicated by an arrow mark B by the rotational force transmitted from the roller 1 by the friction between the two rollers 1 and 2 in the nip N. Designated by a referential code 15 is a roller cleaner, which comprises: a roll of cleaning web 15a; a web supply shaft 15b which holds the roll of cleaning web 15a; a web take-up shaft 15c; and a roller 15d which keeps the portion of the web, which is between the shafts 15b and 15c, pressed upon the peripheral surface of the roller 1. Thus, the toner having transferred onto the peripheral surface of the roller 1 is wiped away by the portion of the web, which is in contact with the peripheral surface of the roller 1, to clean the peripheral surface of the roller 1. The web roll 5a on the shaft 15b is intermittently unrolled from the shaft 15b, and is taken up by the shaft 15c so that the portion of the web, which is in contact with the roller 1, is intermittently replaced little by little with the upstream portion of the web 15a.

In this embodiment, the recording sheet P is conveyed through the apparatus F in such a manner that when the recording sheet P is conveyed through the apparatus F, its center in terms of the lengthwise direction of the roller 1 remains aligned with the center of the recording sheet passage of the apparatus F. Designated by a referential code S is the referential line (theoretical center line). That is, the recording sheet P is conveyed through the apparatus F in such a manner that when the recording sheet P is conveyed through the apparatus F, its center in terms of the lengthwise direction of the roller 1 remains aligned with the center of the lengthwise direction of the roller 1 (center of heat generation range of roller 1) regardless of the size of the recording sheet P. In the case of the image forming apparatus in this embodiment, the size of the widest sheet of recording medium (which may be referred to as large recording sheet P hereafter), in terms of the lengthwise direction of the roller 1, which is conveyable through the image forming apparatus, equals the dimension (297 mm) of the short edges of a sheet of size A3, for example, whereas the narrowest sheet of recording medium (which hereafter may be referred to as small sheet) equals the dimension (148 mm) of the short edges of a sheet of size A5, for example. A referential code P1 stands for the dimension of the foot print of the large sheet in terms of the lengthwise direction of the roller 1, and P2 stands for the dimension of the foot print of the small sheet in terms of the lengthwise direction of the roller 1. Also in terms of the lengthwise direction of the roller 1, the position of the thermistor 11 corresponds to the center of the roller 1, that is, roughly the center of the path P2 of a small sheet. That is, the thermistor 11 is positioned so that it will be within the recording sheet path regardless of the recording sheet dimension in terms of the rotational axis direction of the roller 1.

As the main electric power source switch (unshown) of the image forming apparatus is turned on, the control circuit 100 starts up the image forming apparatus, and also, starts operating the apparatus in the startup mode. As for the fixing apparatus F, the control circuit 100 starts the process for increasing the temperature of the roller 1 of the fixing apparatus F to a preset startup temperature level Tw (which is 195° C. in this embodiment and will be referred to as startup temperature Tw). That is, the control circuit 100 starts rotating the roller 1 by turning on the roller driving power source Ml. Thus, the roller 2 begins to be rotated by the rotation of the roller 1. Further, the control circuit 100 begins flowing high frequency electric current through the coil 6 by starting up the inverter 101, whereby alternating high frequency magnetic flux is generated in the adjacencies of the coil 6. Thus, heat is generated in the metallic core 1a of the roller 1 by electromagnetic induction, causing thereby the roller 1 to increase in temperature to the preset startup temperature Tw. The upward increase in the temperature of the roller 1 is detected by the thermistor 11, and the information of the detected change in the temperature of the roller 1 is inputted into the control circuit 100. As soon as the temperature of the roller 1 reaches the startup temperature Tw, the control circuit 100 puts the image forming apparatus on standby (places apparatus in standby mode). While the image forming apparatus is in the standby mode, the control circuit 100 controls the amount by which the high frequency current is flowed from the inverter 101 to the coil 6 so that the temperature of the roller 1 remains at a preset standby level Ts (standby temperature, which is 195° C., that is, the same as startup temperature Tw). Then, as an image formation start signal is inputted into the control circuit 100 while the image forming apparatus is in the standby mode, the control circuit 100 starts the image formation mechanism of the image forming apparatus, whereby an unfixed toner image t is formed on the recording sheet P. Further, the control circuit 100 controls the inverter 101 so that the temperature of the roller 1 increases to the preset fixation temperature Tf (which is 190° C. in this embodiment), that is, the temperature level at which the image on the recording sheet P is heated during the image forming operation, and remains at the fixation temperature Tf. Then, the recording sheet P on which an unfixed toner image t is present is conveyed through the nip N while remaining pinched by the two rollers 1 and 2. Thus, the toner image t on the recording sheet P is thermally fixed to the surface of the recording sheet P by the heat from the roller 1, the temperature of which is being maintained at the preset fixation temperature Tf, and the pressure in the nip N. During the image heating process (image fixing process), the control circuit 100, which is a means for controlling the amount by which electric power is flowed, controls the amount by which high frequency current is flowed from the inverter 101 to the coil 6, so that the temperature of the heat roller 1 is kept at the fixation temperature Tf across roughly the entirety of the portion of the heat roller 1, which corresponds to the recording sheet path P1. More specifically, the control circuit 100 controls the amount by which the electric current is flowed from the inverter 101 to the coil 6, by controlling the electric current in amperage and frequency, in response to the amount of difference between the output of the thermistor 11 and the preset startup temperature Tw, between the output of the thermistor 11 and the preset standby temperature Ts, or between the output of the thermistor 11 and the fixation temperature Tf. The preset startup temperature Tw, standby temperature Ts, and fixation temperature Tf are referred to together as preset control temperatures T (target temperatures). As the control circuit 100 detects that the temperature level detected by the thermistor 11 equals the anomaly detection temperature Te (erroneously high temperature, which is 225° C. in this embodiment), which is higher than the preset target temperature, the control circuit 100 determines that the temperature of the fixing apparatus F is abnormal in temperature. Then, it immediately stops sending the high frequency electric current from the invertor 101 to the coil 6. That is, in this embodiment, as soon as the control circuit 100 determines that the temperature level detected by the thermistor 11 is no less than the anomaly detection temperature Te, which is higher than the preset target temperature T, it stops heating the roller 1. In other words, the control circuit 100 functions also as a protective means.

Next, referring to FIG. 3(a), the principle based on which heat is generated in the metallic core 1a of the roller 1, that is, the principle of the heat generation in the metallic core 1a by electromagnetic induction, will be described. To the coil 6, alternating electric current is supplied from the invertor 101. Thus, the formation and extinction of a magnetic flux, designated by an arrow mark H, occurs in the adjacencies of the coil 6. This magnetic flux H is guided by the magnetism passage (guide way) formed by the core 5 (combination of portions 1 and 2) and metallic core 1a. In response to the changes in the magnetic flux H formed by the coil 6, eddy current occurs in the roller 1 in the direction to generate such a magnetic flux that counters the change of the magnetic flux generated by the coil 6, in the metallic core 1a. This eddy current is indicated by an arrow mark C. The eddy current C concentrates to the portion of the surface layer of the metallic core 1a, which faces the coil 6 (skin effect), generating thereby heat by an amount which is proportional to the amount of the surface resistance Rs (Ω) of the metallic core 1a. The skin depth δ (m) and skin resistance Rs (Ω) of the metallic core 1a are obtainable from the frequency f (Hz) of the alternating electric current supplied to the coil 6, and the magnetic permeability μ (H/m) and specific resistivity ρ (Ω.m) of the metallic core 1a, with the use of Equations 1 and 2 given below. Further, the amount of electric power W which is generated in the metallic core 1a is obtainable by Equation 3, which shows the amount If (A) of the eddy current induced in the metallic core 1a.

$$\begin{matrix}δ = \sqrt{\frac{ρ}{πμ f}} & ( 1 ) \\ Rs = \frac{ρ}{δ} = \sqrt{πμρ f} & ( 2 ) \\ W ∝ Rs \int {\vert If \vert}^{2} d s & ( 3 )\end{matrix}$$

As will be evident from the equations given above, what is necessary to increase the amount by which heat is generated in the metallic core 1a is to increase the amount If of the eddy current, and/or to increase the metallic core 1a in skin resistance Rs. What is necessary to increase the amount of the eddy current If is to strengthen the magnetic flux generated by the coil 6, and/or to increase the magnetic flux in the amount of change. That is, what is necessary is to increases the coil 6 in the number of times the coil wires are wound, and/or to use a substance which is higher in magnetic permeability and lower in residual magnetic flux density, as the maternal for the magnetic core 5. Further, the amount by which eddy current If is induced in the metallic core 1a can be increase by reducing the gap a between the core 5 and metallic core 1a, since the reduction in the gap α results in the increase in the amount by which the magnetic flux is guided into the metallic core 1a. On the other hand, what is necessary to increase the metallic core 1a in the skin resistance Rs is to increase in frequency f the alternating current to be supplied to the coil 6 to reduce the magnetic core 1a in skin depth, and/or to select a substance which is high in magnetic permeability μ and high in specific resistivity, as the material for the metallic core 1a.

Next, the curie temperature Tc is described. Generally, as a highly magnetic member is heated close to its curie temperature which is specific to the material of which the member is made, it reduces in spontaneous magnetization, reducing thereby in magnetic permeability μ. Therefore, if the temperature of the metallic core 1a, which is the electrically conductive portion of the roller 1, exceeds the curie temperature Tc of the material of which it is made, it reduces in the skin resistance Rs. Consequently, it reduces in the amount W by which heat is generated therein. Also generally, it is not true that as the temperature of the metallic core 1a becomes virtually equal to the curie temperature Tc of the material of which the metallic core 1 is made, the metallic core 1a suddenly changes in magnetic permeability μ. The metallic core 1a begins to change (reduce) in magnetic permeability at a magnetic permeability change (loss) start temperature Tc′, which is lower than the curie temperature Tc. In this embodiment, the magnetic permeability of the metallic core 1a is measured with the use of the following method. The equipment used for the measurement is a B-H analyzer (product of Iwatsu Test Instruments Co., Ltd; Model SY-8232). The magnetic permeability of a test piece was measured with the primary and secondary coils of the analyzer wound around the test piece, while flowing alternating electric current which was 20 kHz in frequency. After the coils were wound around the test piece, the combination was placed in a thermostatic chamber and was left therein until the chamber became stable in temperature. Then, the test piece was measured in magnetic permeability. Then, the obtained values of the magnetic permeability of the test piece were plotted in a graph, in FIG. 3(b), the vertical axis of which stands for the magnetic permeability of the test piece, and the horizontal axis of which stands for the temperature, finding the dependency of the amount of the magnetic permeability of the test piece upon the temperature of the test piece. That is, the dependency of the magnetic permeability of the test piece upon the temperature of the test piece can be proven by measuring the amount of the magnetic permeability of the test piece while changing the thermostatic chamber in temperature. As the results of the measurement of the amount of the magnetic permeability of the test piece were plotted in a graph, in FIG. 3(b), the vertical axis of which stands for the magnetic permeability of the test piece, and the horizontal axis of which stands for the temperature of the test piece, the dependency of the magnetic permeability of the test piece upon the temperature of the test piece became as indicated by the line in FIG. 3(b), which has a couple of distinctively curved portions.

In this embodiment, the magnetic permeability loss start temperature Tc′ and curie temperature Tc of the magnetic core 1a were obtained using the following method. Referring to FIG. 3(b), that is, the graph in which the line with distinctively curved portions shows the dependency of the magnetic permeability of the magnetic core 1a upon the temperature of the magnetic core 1, the section of the line, which corresponds to the temperature range from the room temperature to the preset target temperature T (which is the same as fixation temperature Tf (=190° C.)) is referred to as a section (1), and the section of the line, which corresponds to the temperature range from the target temperature T to the point at which the metallic core 1a began to slow down in the rate at which its magnetic permeability decline, is referred to as a section (2). The section of the line, which corresponds to the temperature range in which the magnetic permeability of the metallic core 1a was stable at its lowest level, is referred to as a section (3). The magnetic permeability loss start temperature Tc′ is the temperature level which corresponds to the intersection of the extension of the straight portion a of the section (1), and the extension of the straight portion of the section (2). In this embodiment, the curie temperature Tc is the temperature level which corresponds to the intersection of the extension of the roughly straight portion b of the section (2), and the extension of the roughly straight portion c of the section (3). The roughly straight portion a of the line is tangential to the line which indicates the dependency of the magnetic permeability of the metallic core 1a upon the temperature of the metallic core 1a, at the target temperature T. Incidentally, in a case where there are two or more target temperatures (T), the highest of the multiple target temperatures is used as the target temperature T. The roughly straight portion c corresponds to 1 in relative magnetic permeability. In FIG. 3, the roughly straight portion c of the section 3 does not coincides with the line which indicates the dependency of the magnetic permeability of the metallic core 1a upon the temperature of the metallic core 1, because the line was drawn to clearly show the presence of the roughly straight portion c. That is, fundamentally, the former coincides with the latter. In this embodiment, the roughly straight portion b appears as shown in FIG. 3. However, in the case of a metallic core (1a) which does not linearly decline in relative magnetic permeability, the straight portion b, is the portion of the section (2), which is highest in gradient, or a straight line which is tangential to the portion of the section (2), at the point which is highest in gradient. Next, referring to FIG. 2(a) which shows the structure of the image heating apparatus in this embodiment, the position of the thermistor 11 corresponds to the center of the roller 1, which roughly corresponds to the center of the path P2 of the small recording sheet, in terms of the lengthwise direction of the roller 1. Therefore, the temperature of the portion of the roller 1, which corresponds to the path P2, that is, the path of the smallest recording sheet, is kept at the preset target temperature T (startup temperature Tw, standby temperature Ts, or fixation temperature Tf), which is lower than the magnetic permeability loss start temperature Tc′. In this embodiment, in the case where there are two more target temperatures (T), all the target temperatures (T) are lower than the magnetic permeability loss start temperature Tc′. The temperature of the portions of the roller 1, which correspond in position to the portions of the recording sheet passage, which is outside the portion P2, automatically converges to the preset level at which the amount by which heat is generated in the metallic core 1a is offset by the amount by which heat radiates from the metallic core 1a, as the amount by which heat is generated in the metallic core 1a is reduced by the decline in the magnetic permeability of the metallic core 1a.

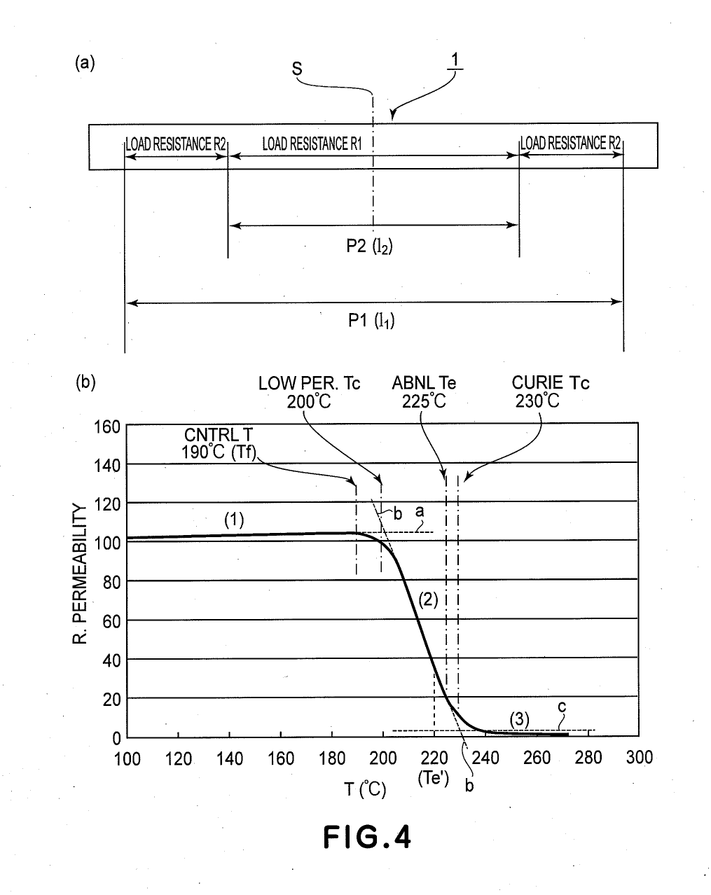

FIG. 4(a) is a schematic drawing for conceptually describing the overall amount of load resistance Rn (Ω) of the coil 6 when the out-of-sheet-path-portions of the image heating member are significantly higher in temperature than the sheet-path-portion of the image heating member, because of the continuously conveyance of a substantial number of recording sheets through the apparatus F. It is assumed that because a substantial number of small recording sheets have been continuously conveyed through the apparatus F, only the lengthwise end portions of the roller 1 have become higher in temperature than the curie temperature. In this situation, it is practical to think that in terms of electrical resistance, the coil 6 is a serially connected combination of the portions which are less in electrical load resistance than that at the curie temperature, and the portion which is greater in load resistance than that at the curie temperature. Thus, the overall amount of the load resistance Rn (Ω) of the coil 6 can be expressed in the form of Equation 4, in which R1 (Ω/m) stands for the load resistance per unit length of the portion when the portion is no higher in temperature than its curie temperature; R2 (Ω/m): the amount of load resistance of the coil 6 per unit length when the coil 6 is higher in temperature than its curie temperature; 11: the width of the path of the large recording sheet; and 12 stands for the width of the path of the small recording sheet. Further, the amount of the load resistance Re of the coil 6 when the temperature of the metallic core 1a has become abnormally high across its entire range because of the occurrence of an anomaly, can be expressed in the form of Equation 5. Thus, Equation 6 can be obtained from Equations 4 and 5. Since R1 is always greater than R2, it is evident that Rn is greater than R2.

Rₙ=R₁l₂+R₂(l₁−l₁) (4)

Rₑ=R₂l₁ (5)

Rₙ−Rₑ=l₂(R₁−R₂) (6)

In this embodiment, the amperage and frequency of the high frequency electric current to be supplied to the coil 6 are determined based on the above described load resistance Rn of the coil 6 when the out-of-sheet-path-portions of the roller 1 are abnormally higher in temperature than the sheet-path-portion of the roller 1. Therefore, when the temperature of the out-of-sheet-path-portion of the roller 1 is abnormally high, the load resistance of the coil 6 is smaller than when it is in the normal range, allowing electric current to flow through the coil 6 by an abnormally large amount. Thus, the inverter 101 becomes overloaded, sometimes abnormally increasing in temperature and/or being damaged in an extreme case. In this embodiment, therefore, the magnetic permeability loss start temperature Tc′ for the roller 1 is set to a value which is greater than the preset value for the target temperature T for the roller 1 (startup temperature Tw, standby temperature Ts, or fixation temperature Tf). Further, the curie temperature Tc is set to a value which is greater than that for the anomaly detection temperature Te. By setting values for the abovementioned critical temperatures as described above, the temperature anomaly of the apparatus F (apparatus is excessively high in temperature) can be detected before the temperature of the metallic core 1a exceeds the curie temperature of the metallic core 1a. Therefore, even if an anomaly occurs to the apparatus F, the anomaly can be detected before the inverter 101 is subjected to an excessive amount of load.

The metallic core 1a of the roller 1 (image heating member) is made of a magnetic alloy which has been adjusted in the amount of magnetism, as described above. In a case where the wall thickness t of the metallic core 1a is less than its skin depth, the amount by which heat is generated in the metallic core 1a is proportional to the square root of the magnetic permeability of the metallic core 1a. In a case where the roller 1 is controlled in temperature when the temperature of the roller 1 is in a range in which the metallic core 1a of the roller 1 significantly changes in magnetic permeability, the amount by which heat is generated in the metallic core 1a varies. Therefore, in order to precisely control the temperature of the roller 1, the temperature of the roller 1 has to be controlled when the metallic core 1a is small in the amount of change in magnetic permeability, that is, when the temperature of the metallic core 1a (roller 1) is no higher than the magnetic permeability loss start temperature Tc′. On the other hand, when the metallic core 1 is lowest, that is, 1, in relative magnetic permeability, that is, when the temperature of the metallic core 1a is no less than the curie temperature of the metallic core 1a, the magnetic core 1a is nonmagnetic. When the apparatus F is in the above described state, the magnetic flux leaks out of the roller 1, reducing thereby in heat generation efficiency. The reduction in heat generation efficiency results in the overloading and overheating of the invertor 101, which sometimes damages the invertor 101. Thus, the anomaly detection temperature Te is set to be lower than the curie temperature Tc, making it possible to preventing the apparatus F from excessively increasing in temperature before the invertor 101 is overloaded, even when the apparatus F erroneously increases in temperature. In other words, as the target temperature T, magnetic permeability loss start temperature Tc′ and anomaly detection temperature Te, and curie temperature Tc are preset so that their relationship satisfies the following Inequality (T≦Tc′<Te<Tc), the temperature anomaly of the image heating apparatus, the heat generating member of which is made of a metallic alloy preset in magnetic permeability, can be detected before the electric power source for the apparatus F becomes overloaded, and therefore, can prevent the electric power source from being damaged.

The values to which the above described referential temperature levels are preset in this embodiment are not intended to limit the present invention in scope. That is, those referential temperature levels may be preset in consideration of the properties of the toner to be used for image formation, structure of the image heating apparatus, heat distribution of the image heating member, temperature ripple and/or temperature overshoot resulting from the temperature control, errors in the temperature detection by the temperature detecting means, etc., and such modifications do not affect the present invention in its effectiveness. Further, the two or more values may be preset for the standby temperature Ts and fixation temperature Tf, in consideration of the ambience in which the image heating apparatus in accordance with the present invention is used, thickness of the recording medium (paper) to be conveyed through the image heating apparatus, amount of the heat in the roller 1, etc., and such modifications do not affect the present invention in its effectiveness. Further, in the first embodiment, the image heating apparatus was an image heating apparatus of the heat roller type, that is, an image heating apparatus which employs a heat roller. However, the present invention is also applicable to an image heating apparatus of the heat belt type, that is, an image heating apparatus which employs an endless belt as the heating member, which is obvious. Further, the prevent invention is also applicable to an image heating apparatus which employs a clad roller, which has multiple metallic layers which are different in material, as long as one of the layers is made of a metallic alloy which has been adjusted in the amount of magnetic permeability. Further, the present invention is also applicable to a color image forming apparatus which forms color images by layering multiple monochromatic images, different in color, on a sheet of recording medium, and such an application brings out the same effects as those described above. Further, in this embodiment, the roller 1 was placed in the hollow of the roller 1. However, the present invention is also applicable to an image heating apparatus, the coil (6) of which is outside its roller (1). Incidentally, an image heating apparatus may be provided with an additional protective means, for example, a protective circuit which interrupts the electric power supply to the coil 6 in response to the temperature of the roller 1 detected by the thermistor 11, and/or the detected electrical resistance of the coil 6. With the provision of such a protective means, an image heating apparatus can be prevented from overheating, even if the image heating apparatus begins to overheat because of the malfunction of the controlling means 100.

### Embodiment 2

As one of the means for reducing an image forming apparatus in energy consumption and warm-up time is to employ an image heating member 1 (rotational heating member) which is smaller in thermal capacity. If the image heating apparatus in the first embodiment is replaced with an image heating member (1) whose metallic core (1a) is less in wall thickness, the skin depth δ obtainable from Equation 1 becomes greater than the wall thickness of the metallic core (1a). Thus, the coil 6 reduces in load resistance even when the temperature of the metallic core (1a) is no higher than the curie temperature Tc. Thus, the coil 6 is increased in the amount by which electric current flows through the coil 6. This phenomenon occurs because a part of the magnetic flux induced by the coil 6 leaks from the metallic core (1a). In other words, setting the anomaly detection temperature Te to a value in the range in which the skin depth δ is less than the wall thickness of the metallic core 1a makes it possible to detect the anomaly of the image heating apparatus before the invertor 101 is overloaded. The value μ′ of the magnetic permeability μ of the metallic core 1a, at which the skin depth δ of the metallic core 1a is equal to the wall thickness of the metallic core 1a, can be obtained from Equation 7, in which t(m) stands for the wall thickness of the metallic core 1a of the image heating member 1.

$${μ}^{′} = \frac{ρ}{π {ft}^{2}} \qquad ( 7 )$$

In this embodiment, the wall thickness of the metallic core 1a was 0.5 mm, and the magnetism-adjusted metallic alloy was 8.0×10⁻⁷ Ω.m in specific resistivity. The high frequency electric current supplied to the coil 6 was 20 kHz in frequency. It is evident from Equation 7 that in the case of the image heating apparatus in this embodiment structured as described above, when the metallic core 1a was 5.1×10⁻⁵ H/m (roughly 40 in relative magnetic permeability), the skin depth of the metallic core 1a is equal to the wall thickness of the metallic core 1a. Further, it is evident from FIG. 3(b), which shows the dependency of the magnetic permeability of the metallic core 1a upon the temperature of the metallic core 1a, that the critical temperature Te′ (anomaly detection temperature), at which the skin depth of the metallic core 1a is equal to the wall thickness of the metallic core 1a is 220° C. In other words, in the case of the image heating apparatus in this embodiment structured as described above, if the temperature of the metallic core 1a exceeds 220° C., the magnetic flux induced by the coil 6 partially leaks from the metallic core 1a, and therefore, the coil 6 reduces in load resistance, which in turns overloads the invertor 101. Thus, it is desired that the anomaly detection temperature Te is set to be no higher than the critical temperature Te′, which is 220° C. With the anomaly detection temperature Te set to be no higher than the critical temperature Te′, even if the roller 1 becomes abnormally high in temperature, the magnetic flux induced by the coil 6 does not leak from the metallic core 1a, and therefore, the invertor 101 is not overloaded. In other words, even if an image heating apparatus is reduced in the wall thickness of the metallic core 1a of its image heating member 1, the anomaly can be detected before it becomes serious.

In a case where the metallic core 1a of the roller 1 as an image heating member is made of an magnetism-adjusted metallic alloy, as the skin depth of the metallic core 1a of the roller 1 exceeds the thickness t of the wall of the metallic core 1a, the magnetic flux induced by the coil 6 leaks from the roller 1, reducing thereby the metallic core 1a in heat generation efficiency. The reduction in the heat generation efficiency results in the overloading and overheating of the invertor 101, which sometimes damages the invertor 101. Thus, it is desired that the anomaly detection temperature Te is set so that it is higher than the magnetic permeability loss start temperature Tc′, and also, so that when the temperature of the metallic core 1a is at the anomaly detection temperature Te, the skin depth of the metallic core 1a is less than the wall thickness t of the metallic core 1 (which is greater than skin depth of metallic core 1a when temperature of metallic core 1a is at anomaly detection temperature Te). With the anomaly detection temperature Te set as described above, the anomaly in the temperature of an image heating apparatus, the image heating member of which is formed of an magnetism-adjusted metallic alloy, can be detected before the temperature of the image heating apparatus becomes higher than the critical level, and therefore, the electric power source for the image heating apparatus is unlikely to break down. That is, even if the image heating apparatus becomes erroneously high in temperature, the image heating apparatus is stopped before it destroys itself and the invertor 101 becomes overloaded. The image heating apparatus in this embodiment may be modified as necessary to optimize the apparatus for the image forming apparatus by which it is employed, like the image heating apparatus in the first embodiment.

In this embodiment, the temperature of the image heating member detected by the thermistor 11 was compared to the anomaly detection temperature Te to interrupt the operation of the image heating apparatus. However, instead of the thermistor, the image heating apparatus may be provided with a thermo-switch or a thermal fuse which interrupts the electric current supply to the coil 6 as its temperature reaches the anomaly detection temperature Te. The effects of the provision of such a thermo-switch or a thermal fuse are the same as the above described effects of the thermistor.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 242252/2009 filed Oct. 21, 2009 which is hereby incorporated by reference.

What is claimed is:

1. An image heating apparatus comprising:
a coil;
a rotatable image heating member for generating heat by a magnetic flux generated by said coil to heat an image on a recording material;
a voltage source for applying a high frequency current to said coil;
a temperature detecting member for detecting a temperature of said image heating member;
control means for controlling electric power supply to said coil from said voltage source on the basis of an output of said temperature detecting member such that the temperature of said image heating member is maintained at a set temperature T; and
protecting means for stopping the electric power supply to said coil when the output of said temperature detecting member indicates a predetermined abnormal temperature Te,
wherein at least a part of said image heating member is made of a magnetism-adjusted alloy having a predetermined magnetic permeability decrease start temperature Tc′ and a predetermined Curie temperature, and
wherein T≦Tc′<Te<Tc.

2. An apparatus according to claim 1, wherein said temperature detecting member is disposed to detect a temperature in a region through which a maximum width of recording materials usable with said apparatus, with respect to a rotational axis direction of said image heating member.

3. An apparatus according to claim 1, wherein said magnetism-adjusted alloy has a thickness t which is larger than a skin depth thereof at the time when a temperature of said magnetism-adjusted alloy is said abnormality detected temperature. Te.

4. An image heating apparatus comprising:
a coil;
a rotatable image heating member for heat generating heat by a magnetic flux generated by said coil to heat an image on a recording material;
a voltage source for applying high frequency current to said coil;
a control means for controlling electric power supply to said coil from said voltage source such that a temperature of said image heating member is maintained at a set temperature; and
a temperature detecting member for detecting a temperature of said image heating member having a function of blocking the electric power supply to said coil when the temperature reaches a predetermined abnormal temperature Te,
wherein at least a part of said image heating member is made of a magnetism-adjusted alloy having a predetermined magnetic permeability decrease start temperature Tc′ and a predetermined Curie temperature, and
wherein T≦Tc′<Te<Tc.

5. An apparatus according to claim 4, wherein said temperature detecting member is disposed to detect a temperature in a region through which a maximum width of recording materials usable with said apparatus, with respect to a rotational axis direction of said image heating member.
